(19) United States
(12) Patent Application Publication
(10) Pub. No.: US 2005/0237511 A1
(43) Pub. Date: Oct. 27, 2005

(54) Optical beam detection device and optical beam detection system using therewith

(76) Inventors: Koichi Takahashi, Tokyo (JP); Yoshinori Arimoto, Tokyo (JP)

Correspondence Address: KENYON & KENYON, 1500 K STREET NW, SUITE 700, WASHINGTON, DC, 20005, US

(21) Appl. No.: 11/065,103

(22) Filed: Feb. 25, 2005

(30) Foreign Application Priority Data
Mar. 1, 2004 (JP) P 2004-056769

(51) Int. Cl. G01J 1/00

(52) U.S. Cl. 356/121

(57) ABSTRACT

The present invention relates to an optical beam detection device for detecting deviation in the optical axis of light beams from a reference optical axis, the optical beam detection device provided with a converging member for converging the light beams; a light receiving surface that is disposed near the position where light beams that have an optical axis that coincides with the reference optical axis are converged by the converging member; an optical path deflector for deflecting light beams that have an optical axis that deviates from the reference optical axis, after they have passed through the converging member; and a light detecting element for detecting the light beams that have been deflected by the optical path deflector.

### BACKGROUND OF THE INVENTION

1. Field of the Invention

The present invention relates to an optical beam detection device and an optical system using therewith. More specifically, the present invention relates to an optical beam detection device that detects the optical axis inclination in a light receiving device used for optical tracking in spatial light communications. The present invention further relates to an optical system using therewith.

Priority is claimed on Japanese Patent Application No. 2004-56769, filed Mar. 1, 2004, the content of which is incorporated herein by reference.

2. Description of Related Art

As a conventional optical beam detection device, there is a design in which a portion of the light beams are branched at a beam splitter, and are received at a quadrant ditector or other such optical sensor. The direction of inclination of the optical axis of the light beams is then detected based on the position of the received light spot. However, this device has an inconvenience in that, when employed in spatial light communications that have an optical tracking function, a portion of the received light is always used for detecting the inclination of the optical axis. For this reason, the received light that is detected at the light receiving element is weakened. In the case of long-distance communications in particular, where the light that is to be received is itself already weak, when the light employed for inclination detection is separated from this light, then the light received at the light receiving element becomes extremely weak, leading to a problematic fall in the signal-to-noise (S/N) ratio.

In order to resolve this problem, optical detection methods that do not employ a quadrant ditector or other such optical sensor have been proposed.

For example, as shown in FIG. 11A, the light beam tracking/receiving device disclosed in Japanese Patent Application, First Publication No. H05-122155 includes a vertical drive mirror 1 for tilt driving in the vertical direction; a horizontal drive mirror 2 for tilt driving in the horizontal direction; a converging lens 3; and a light receiving element 4. In order to detect and correct the inclination of the optical axis using this device, first, vertical drive mirror 1 and horizontal drive mirror 2 are driven by two dimensional control using control voltage. As a result, the light spot converged on light receiving element 4 moves over light receiving element 4, describing a circular locus. The detection signal detected by light receiving element 4 varies periodically as shown in FIG. 11B, according to the amount that the light spot projects beyond light receiving element 4. On the other hand, when the light spot does not project beyond light receiving element 4, then the detection signal becomes constant.

Accordingly, since the angle of mirrors 1,2 is adjusted so that there is no change generated in the level of the detection signal, it is possible to detect the light without incurring loss. Moreover, because light receiving element 4 serves both to detect the deviation in the optical axis and to detect the optical signal, an element for removing a quantity of light is not necessary. Thus, there is no loss of received light.

### SUMMARY OF THE INVENTION

The optical beam detection device of the present invention is for detecting deviation in the optical axis of light beams from a reference optical axis, comprising:

a converging member for converging light beams;

a light receiving surface that is disposed near the position where light beams that have an optical axis that coincides with the reference optical axis are converged by the converging member;

an optical path deflector for deflecting light beams that have an optical axis that deviates from the reference optical axis, after they have passed through the converging member; and

a light detecting element for detecting light beams that have been deflected by the optical path deflector.

In the optical beam detection device of the present invention, it is desirable that the light receiving surface be formed in an integral manner with the optical path deflector.

In the optical beam detection device of the present invention, it is desirable that the optical path deflector have a reflecting surface that is disposed to the periphery of the light receiving surface.

In the optical beam detection device of the present invention, it is desirable that the optical path deflector have a reflecting surface, and that this reflecting surface be inclined with respect to the reference optical axis.

In the optical beam detection device of the present invention, it is desirable that the optical path deflector have an incident surface that is provided to the periphery of the light receiving surface in an integral manner therewith, and that forms a transmitting surface; and a reflecting surface that is disposed inclined with respect to the reference optical axis and that deflects light beams that have passed through the incident surface.

In the optical beam detection device of the present invention, it is desirable that the incident surface of the optical path deflector be a surface-reflecting mirror to which a reflective coating has been applied.

In the optical beam detection device of the present invention, it is desirable that the optical path deflector be a prism.

In the optical beam detection device of the present invention, it is desirable that the following conditional expression be satisfied:
25°≦|θ|≦65° (1)
where θ is the angle of incidence at which the optical axis of light beams incident on the reflecting surface for deflecting light beams in the optical path deflector.

In the optical beam detection device of the present invention, it is desirable that the following conditional expression be satisfied:
Sin⁻¹(1/N)≦α (2)
where N is the refractive index of the wavelength employed in the prism medium, and α is the angle of incidence of the principal light rays in the total angle of view that incident on the reflecting surface of the prism.

In the optical beam detection device of the present invention, it is desirable that the following conditional expression be satisfied:
70°<β<110° (3)
where β is the angle formed by the light receiving surface and the optical axis of the light beam.

The optical system according to the present invention comprises an optical beam detection device and a controller for adjusting the optical axis of the light beams so that it coincides with the reference optical axis, based on the detection signal of the light beams detected by the light detecting element.

It is desirable that the optical system according to the present invention further comprise a light deflecting element for adjusting the direction of the light beams that are approaching the converging member, wherein the controller calculate the deviation of the optical axis of the light beams with respect to the reference optical axis and control the light deflecting element so as to diminish deviation of the optical axis.

It is desirable that the optical system according to the present invention further comprise an adjusting member for adjusting the inclination of the whole of the optical system with respect to light beams that are approaching the converging member, wherein the controller calculate the deviation in the optical axis of the light beams with respect to a reference optical axis and control the adjusting member so as to diminish deviation of the optical axis.

### BRIEF DESCRIPTION OF THE DRAWINGS

FIG. 1 is a block diagram showing the optical system according to a first embodiment of the present invention.

FIG. 2 is a diagram showing the optical path in the case where the signal light beams deviate from the reference optical axis in the optical system shown in FIG. 1.

FIG. 3 is a block diagram showing an optical system according to a second embodiment of the present invention.

FIG. 4 is a diagram showing the optical path in the case where the signal light beams deviate from the reference optical axis in the optical system shown in FIG. 3.

FIG. 5 is a diagram showing a first modification of the optical path deflector.

FIG. 6 is a diagram showing a second modification of the optical path deflector.

FIG. 7 is a diagram showing a third modification of the optical path deflector.

FIG. 8 is a diagram showing a forth modification of the optical path deflector.

FIG. 9 is an example of a modification of the structure in the vicinity of the light receiving surface in the optical system according to the second embodiment.

FIG. 10 is a block diagram showing the optical system according to a third embodiment of the present invention.

FIGS. 11A and 11B are diagrams showing a conventional optical beam detection device for detecting the inclination of an optical axis.

### DETAILED DESCRIPTION OF THE INVENTION

An optical system equipped with an optical beam detection device according to the present invention will now be explained with reference to the accompanying figures.

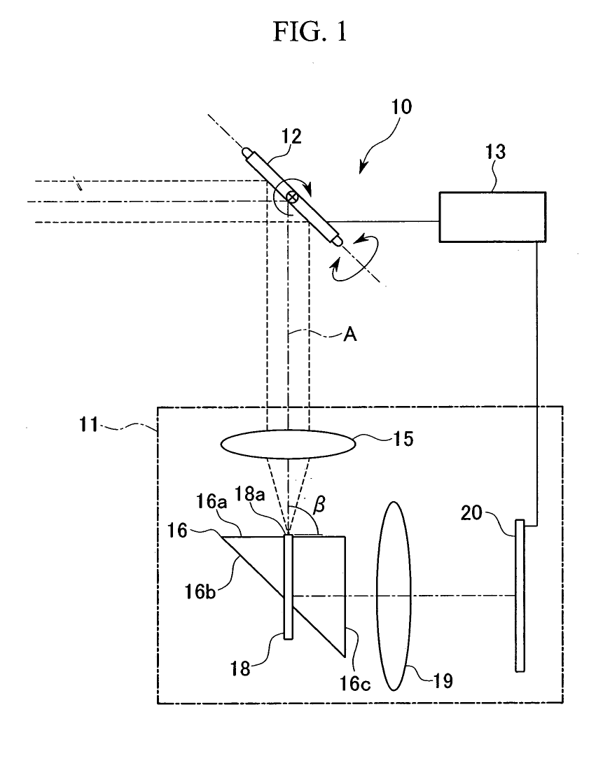

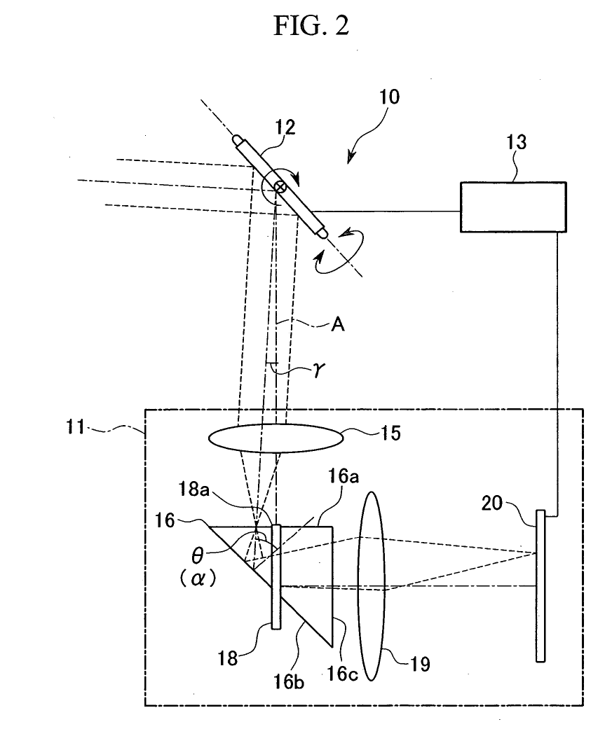

FIGS. 1 and 2 show an optical system 10 according to a first embodiment of the present invention. This optical system 10 is a system for receiving light transmitted from the outside, and is equipped with an optical beam detection device 11 for detecting the deviation in the optical axis of signal light beams transmitted from the outside; a light deflecting element, such as a galvano mirror 12 for example, for directing signal light beams transmitted from the outside into optical beam detection device 11; and a controller 13 for calculating and outputting the amount of correction required for driving galvano mirror 12 in a direction which reduces the deviation in the optical axis based on the detection signal for the deviation in the optical axis of the light beams that is detected by optical beam detection device 11.

Galvano mirror 12 is capable of rotation centered on the two axes, X and Y, and can be tilt driven in an optional angular direction.

Optical beam detection device 11 is provided with a converging lens 15 that is employed as a converging member to transmit and converge the signal light beams from the outside that are reflected at galvano mirror 12. A triangular prism 16 is provided as an optical path deflector near the position of convergence by converging lens 15. As shown in FIG. 1, triangular prism 16 forms a roughly right angled triangular shape when seen from the side for example, and has an incident surface 16a that faces converging lens 15, a reflecting surface 16b that reflects signal light beams that have entered prism 16, and a radiating surface 16c that radiates signal light beams reflected at reflecting surface 16b. Incident surface 16a is a transmitting surface that has undergone AR coating to reduce transparency loss.

An optical fiber 18 is fixed in place inside triangular prism 16 in an integral manner therewith, for use as a light receiving element for receiving signal light beams. Incident end surface 18a (i.e., the light receiving surface) of optical fiber 18 is disposed in the same plane as incident surface 16a (or may project slightly outward or be retracted slightly inward from incident surface 16a). Moreover, in the optical path on which the signal light beams reflected at galvano mirror 12 are converged by converging lens 15, when signal light beams having an optical axis A converge on incident surface 16a for example, these signal light beams are received by optical fiber 18 at its incident end surface 18a which is positioned at or near the position of convergence. The optical axis A of such signal light beams is designated as the reference optical axis.

Reflecting surface 16b of triangular prism 16 is inclined at an angle of 45°, for example, with respect to reference optical axis A. When the optical axis of the signal light beams approaching triangular prism 16 deviate from reference optical axis A, at least a portion of these signal light beams miss incident end surface 18a, pass through incident surface 16a and enter into the prism. There, they undergo total reflection at reflecting surface 16b and approach radiating surface 16c.

An image forming lens 19 which forms an image of the signal light beams reflected at reflecting surface 16b is disposed at a position opposite radiating surface 16c. A detecting element, a CCD 20 for example, is provided at the position of image formation of the signal light beams by image forming lens 19. Based on the position of formation of the received light spot image, CCD 20 can detect the direction and amount of deviation of the signal light beams with respect to the incident end surface 18a of optical fiber 18 as the deviation in the optical axis. A detection signal that includes the direction and amount of this deviation is input to controller 13. Controller 13 then calculates the amount of angular correction for galvano mirror 12 based on the input detection signal, and drives galvano mirror 12.

The inner diameter of the incident end surface 18a of optical fiber 18 is slightly larger than the diameter of the signal light beams just before and after the point of convergence. Further, when the angle formed by incident end surface 18a, which is the light receiving surface, and the optical axis of the signal light beams is designated as β, then it is desirable that angle β satisfy the following conditional expression (3):
70°<β<110° (3)

If angle β is within this range, then the signal light beams can be received with certainty within the incident end surface 18a without being truncated. Note that if β is 90°, the signal light beams will be perpendicular to incident end surface 18a which is the light receiving surface, theoretically resulting in a maximal coupling efficiency in an optical system in which signal light beams are received into an optical fiber. However, in the case of an optical system in which returning light, such as reflected light, has a negative impact on the signal light beams, then it is desirable that incident end surface 18a which is the light receiving surface be relatively inclined slightly with respect to the optical axis, i.e., it is desirable that angle β be slightly greater or smaller than 90°.

When the refractive index in the employed wavelength of the medium of the triangular prism 16 is designated as N, and the incident angle of the principal light rays in the total angle of view that incident on reflecting surface 16b is designated as α, then it is necessary for triangular prism 16 to satisfy the following conditional expression (2) in order for the signal light beams incidenting on triangular prism 16 to be totally reflected at reflecting surface 16b:
Sin⁻¹(1/N)≦α (2)

If the angle α of incidence on reflecting surface 16b in triangular prism 16 is greater than the critical angle, then there is no need to provide a reflective coating to reflecting surface 16b in order to cause total reflection. For example, when triangular prism 16 is formed of optical glass having a refractive index of N=1.52, the critical angle is 41.14° or less. In this case, if the deviation angle γ of the optical axis of the signal light beams with respect to reference optical axis A is in the range of a maximal ±3.86°, then it is possible to detect the signal light beams without carrying out a reflective coating to reflecting surface 16b.

However, when the detection range for the deviation angle γ of the optical axis of the signal light beams with respect to reference optical axis A is made larger than the above range, then the range for incident angle α becomes even larger. In this case, it is necessary to cause total reflection by providing a reflective coating to reflecting surface 16b.

Further, when signal light beams are reflected at reflecting surface 16b of triangular prism 16, then it is desirable that the angle θ of incidence on the reflecting surface 16b satisfy the following conditional expression (1):
25°≦|θ|≦65° (1)

Within the above range, CCD 20 can be disposed at a position separated from reflecting surface 16b, and there is no interference.

The optical system according to the present embodiment is provided with the above design. Next, the action thereof will be explained.

Signal light beams transmitted from the outside approach converging lens 15 of optical beam detection device 11 after being deflected at galvano mirror 12. When the optical axis of the signal light beams coincides with reference optical axis A in an optical path in which signal light beams pass through a converging lens 15, then, as shown in FIG. 1, the signal light beams that have passed through converging beams 15 are converged and the light beams all enter into and are received at the incident end surface 18a of optical fiber 18 which is provided to incident surface 16a of triangular prism 16 at or near the point of convergence. As a result, it is possible to detect all signal light at optical fiber 18.

Further, in the case where the optical axis of the signal light beams deviates from reference optical axis A in an optical path in which signal light beams transmitted from the outside approach converging lens 15 after being deflected at galvano mirror 12, then, as shown in FIG. 2, the signal light beams miss incident end surface 18a on the incident surface 16a of triangular prism 16. These signal light beams pass through incident surface 16a and are totally reflected after incidenting on reflecting surface 16b at a specific incident angle θ. This reflected light passes through radiating surface 16c, forms converged light in the process of passing through image forming lens 19, and is formed as a light spot image on CCD 20.

CCD 20 converts the detection signal for the position of the light spot to an electrical signal and outputs this electrical signal to controller 13. Based on this input electrical signal, controller 13 calculates the amount and direction of deviation with respect to incident end surface 18a of optical fiber 18 which is the light receiving surface. Controller 13 then outputs the direction and amount of deviation as a correction signal for the signal light beams to galvano mirror 12. Galvano mirror 12 is then rotated around the two axes by a specific amount each respectively, so as to eliminate the deviation between reference optical axis A and the optical axis of the signal light beams. As a result, the direction of deflection of the signal light beams which are deflected at galvano mirror 12 is driven toward incident end surface 18a which is the light receiving surface, and the optical axis of the signal light beams is made to coincide with reference optical axis A.

In this way, the signal light beams can be guided into incident end surface 18a.

As explained above, in this embodiment, even when the optical axis of the signal light beams is greatly inclined, to an extent that would not be detected at the light receiving surface for signal light beams in a conventional device, detection of the inclination of the optical axis by CCD 20 is possible. Moreover, since the deviation in the optical axis of the signal light beams with respect to reference optical axis A is corrected using galvano mirror 12, all of the incident light of the signal light beams can be detected at incident end surface 18a which is the light receiving surface, and there is no loss of signal light. For this reason, it is possible to detect extremely weak signal light, and this is optimal for a system of spatial light communication over long distances in which there are large fluctuations in the incident angle of the signal light beams on the light receiving surface.

Other embodiments of the present inventions will now be explained. An explanation will be omitted of aspects that are equivalent to the preceding embodiment, and members and parts that are the same will be assigned the same numeric symbol and will not be explained again here.

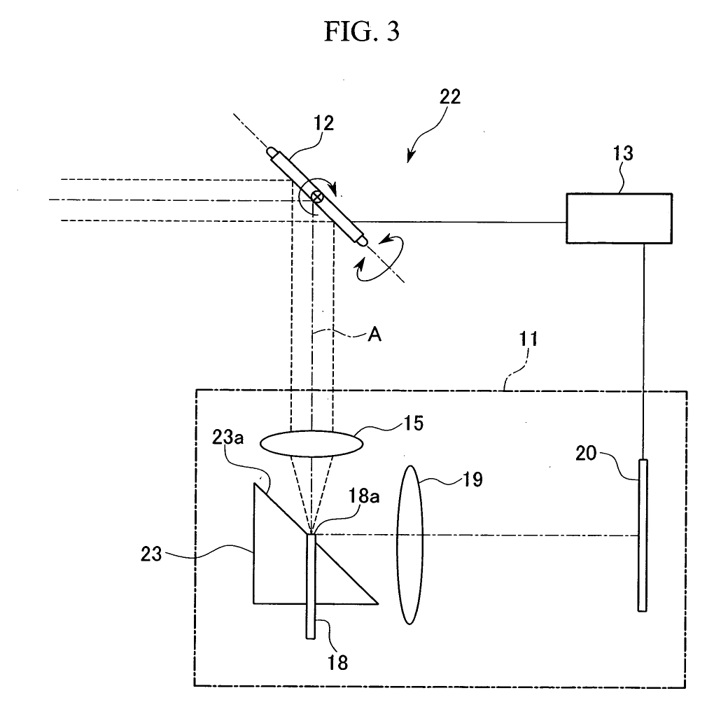

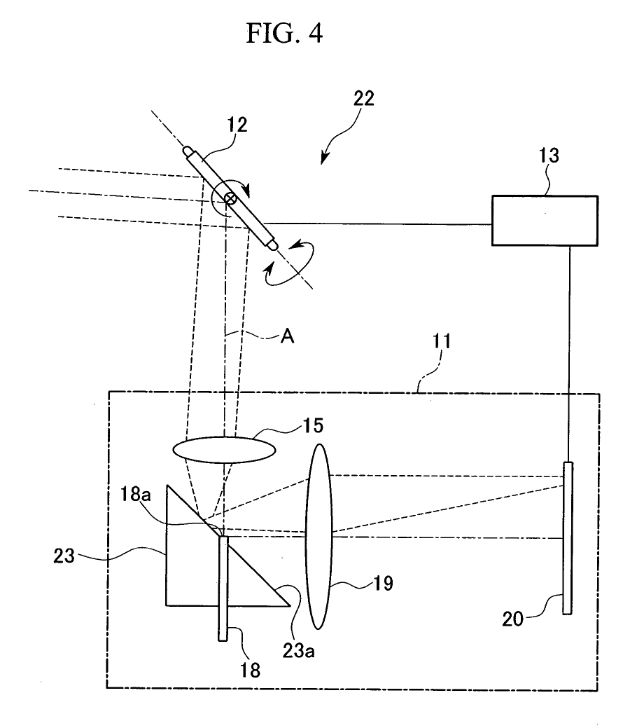

FIGS. 3 and 4 show an optical system 22 according to a second embodiment of the present invention. In the optical system 22 shown in FIGS. 3 and 4, with the exception of triangular prism 23 which forms the optical path deflector, the remainder of the optical system shown here has the same design as the optical system of the first embodiment. The inclined surface of triangular prism 23 forms a reflecting surface 23a, and is treated with a reflective coating. As shown in FIG. 3, this reflecting surface 23a is disposed to a position that faces converging lens 15 and image forming lens 19 respectively, and is inclined at the desired acute angle, 45° for example, with respect to reference optical axis A. Optical fiber 18 is embedded in triangular prism 23, and preferably is disposed on the extension line of reference optical axis A. Incident end surface 18a which forms the light receiving surface is provided at a position that roughly intersects reference optical axis A on reflecting surface 23a. The signal light beams, including reference optical axis A, that are converged after passing through converging lens 15 are received on incident end surface 18a of optical fiber 18 at or near the converging point.

Further, in the case where the optical axis of the signal light beams deviates from reference optical axis A, then the signal light beams are reflected at reflecting surface 23a of triangular prism 23, pass through image forming lens 19 and form an image on CCD 20.

The optical system of this embodiment has the above-described design. Accordingly, when the optical axis of signal light beams from the outside that were deflected by galvano mirror 12 deviate from reference optical axis A, then the light which has converged after passing through converging lens 15, incidents on reflecting surface 23a of triangular prism 23 at an incident angle θ without incidenting on incident end surface 18a, which is the light receiving surface. The signal light beams reflected at reflecting surface 23a pass through image forming lens 19 and converge, forming a light spot image on CCD 20.

CCD 20 outputs the position of the light spot as the detection signal to controller 13. Controller 13 calculates the direction and amount of the deviation with respect to the incident end surface 18a of optical fiber 18 which is the light receiving surface. Controller 13 then outputs a correction signal based on this calculated value, and galvano mirror 12 is rotated by a specific amount around each of the two axes. The direction of deflection of the signal light beams at galvano mirror 12 is driven into incident end surface 18a which is the light receiving surface, and the optical axis of the signal light beams is made to coincide with reference optical axis A (see FIG. 3).

Accordingly, in the same manner as the first embodiment, the deviation in the optical axis of the signal light beams with respect to reference optical axis A is corrected using galvano mirror 12, so that all of the incident light of the signal light beams can be detected at incident end surface 18a which is the light receiving surface, and there is no loss of signal light.

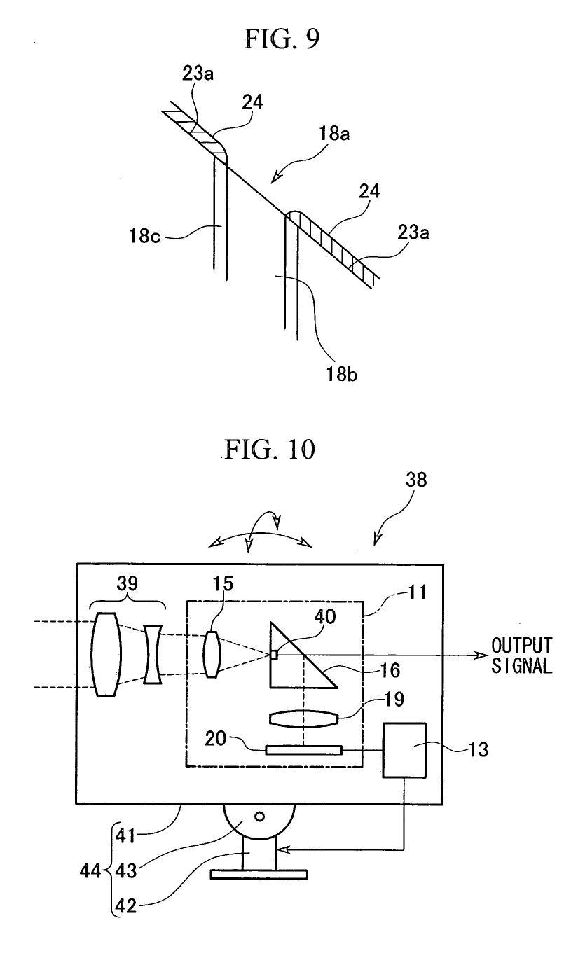

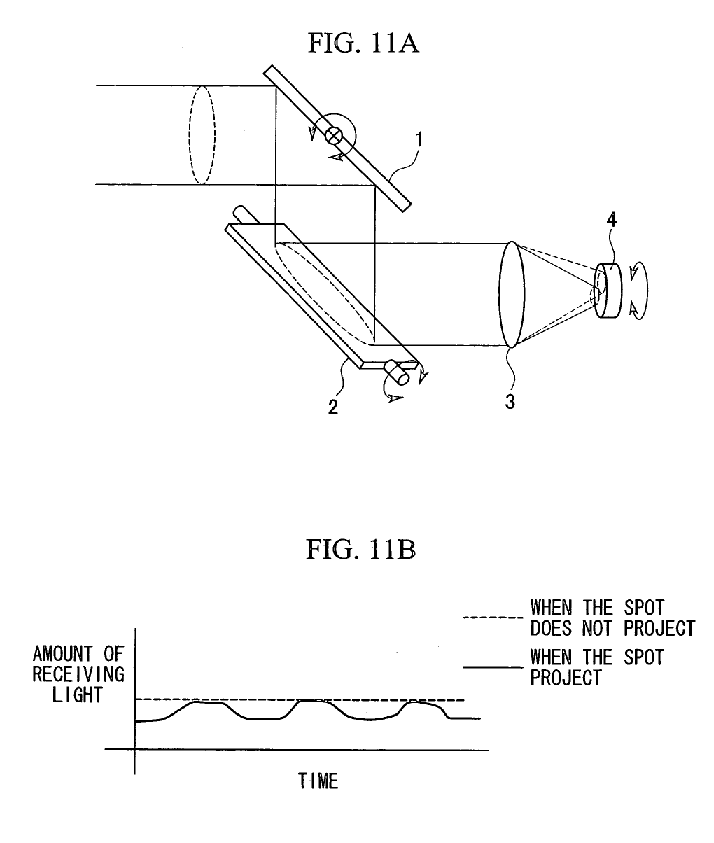

Note that in the above-described second embodiment, the incident end surface 18a of optical fiber 18 is formed in a direction which is perpendicular to reference optical axis A. However, alternatively, it is also acceptable to incline the end surface of incident end surface 18a so as to be in the same plane as reflecting surface 23a, as shown in FIG. 9. In this way, with regard to the end surface of optical fiber 18, cladding 18c, which surrounds core 18b that forms incident end surface 18a, is in the same plane as reflecting surface 23a and forms a portion of reflecting surface 23a. For this reason, the loss of reflected light directed toward CCD 20 becomes even smaller. Note that it is also acceptable to provide a reflective coating layer 24 onto the reflecting surface 23a that is shown in FIG. 9, this coating layer including the end surface of cladding 18c as well.

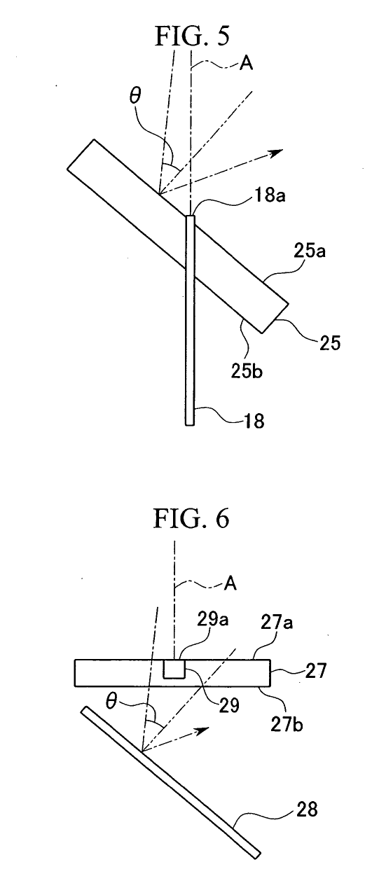

Next, examples of modifications of the optical path deflector and light receiving surface for the optical systems 10 and 22 according to the first or second embodiment will be explained using FIGS. 5 through 8. Note that with the exception of the optical path deflector and the light receiving surface, the remainder of the design is otherwise identical to the embodiments.

FIG. 5 is a vertical cross-sectional view showing an example of the first modification. A parallel plate 25 consisting of a glass member is provided in place of triangular prism 16 and 23 as the optical path deflector in optical system 10 or optical system 22. The first surface (upper surface) of this parallel plate 25 which faces converging lens 15 is a reflecting surface 25a. This reflecting surface 25a is inclined at a suitably acute angle, 45° for example, with respect to reference optical axis A. Moreover, optical fiber 18 is embedded and fixed in place in parallel plate 25. Incident end surface 18a of optical fiber 18 is formed as a light receiving surface on reflecting surface 25a. In FIG. 5, optical fiber 18 extends on the extension line of reference optical axis A, passes through parallel plate 25 in the thickness direction from its second surface (lower surface) 25b, and is fixed in place to parallel plate 25.

As a result of the above-described structure, signal light beams that deviate from reference optical axis A are reflected at reflecting surface 25a and directed toward image forming lens 19 and CCD 20. Controller 13 calculates the amount of correction based on the detection signal detected at CCD 20, and galvano mirror 12 is subjected to biaxial rotation. As a result, deviation of signal light beams from reference optical axis A can be adjusted, and the signal light beams can be made to incident on incident end surface 18a.

Note that in the above-described first modification, the first surface of parallel plate 25 which is opposite converging lens 15 was employed as reflecting surface 25a. Instead, however, it is also acceptable for first surface 25a which is opposite converging lens 15 to be employed as the transmitting surface, and for second surface 25b to be employed as the reflecting surface.

FIG. 6 shows an optical path deflector and light receiving surface according to a second modification. In FIG. 6, in place of triangular prism 16 and 23, a parallel plate 27 consisting of a glass member has instead been disposed to a position facing converging lens 15. Reflecting mirror 28 is disposed to a position opposite converging lens 15 with parallel plate 27 interposed therebetween. The opposing first surface 27a and second surface 27b of parallel plate 27 are both transmitting surfaces, and are preferably roughly perpendicular with respect to reference optical axis A. A photodetector 29, for example, is provided as a light receiving element to first surface 27a facing converging lens 15, at a position intersecting reference optical axis A. For this reason, signal light beams having an optical axis that overlaps with reference optical axis A are received, with this photodetector surface 29a being employed as the light receiving surface.

A reflecting mirror 28 which is positioned at the rear side of parallel plate 27 is disposed inclined at a specific angle, 45° for example, with respect to parallel plate 27. The signal light beams that pass through parallel plate 27 are reflected at reflecting mirror 28 and directed at image forming lens 19.

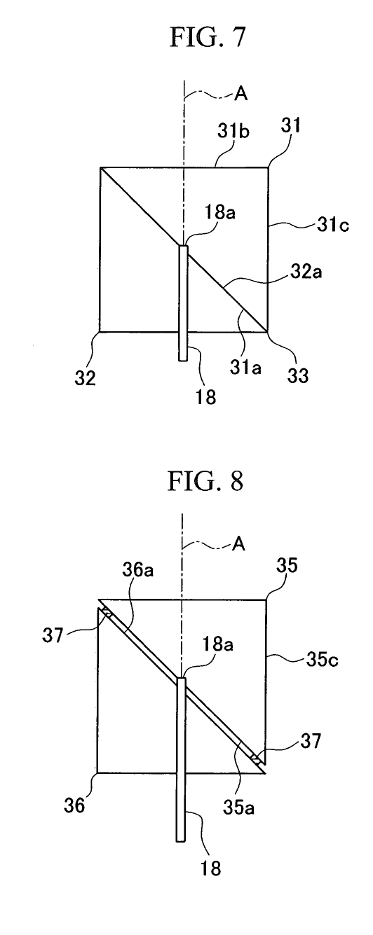

FIG. 7 shows an optical path deflector and light receiving surface according to a third modification. In the optical path deflector shown in FIG. 7, the inclined surfaces 31a and 32a of two triangular prisms 31 and 32 are brought into contact with one another to form joining surface 33. The resulting optical path deflector has a cubic shape. A reflective coating has been provided to joining surface 33, to form a reflecting surface. The first triangular prism 31 employs incident surface 31b, facing converging lens 15, and radiating surface 31c, facing image forming lens 19, as transmitting surfaces. Optical fiber 18 is embedded and fixed in place within the second triangular prism 32, with its incident end surface 18a positioned on joining surface 33. Moreover, incident end surface 18a forms a light receiving surface that is positioned on the extension line of reference optical axis A.

As a result, when the optical axis of the signal light beams coincides with reference optical axis A, the signal light beams are received at incident end surface 18a. When the optical axis of the signal light beams deviates from reference optical axis A, then the signal light beams pass through incident surface 31b, are reflected at joining surface 33, pass through radiating surface 31c and approach image forming lens 19.

Note that the second triangular prism 32 does not transmit light beams. Therefore, it is not absolutely essential that it be a prism. For example, it may be an optional member, such as a metal, which does not transmit light.

FIG. 8 shows an optical path deflector and a light receiving surface according to a forth modification. In the optical path deflector shown in FIG. 8, the respective inclined surfaces 35a and 36a of two triangular prisms 35 and 36 are disposed opposite one another with a slight interval of space therebetween. As a result, this optical path deflector has a cubic shape. In particular, reflecting surface 35a of first triangular prism 35 forms an inclined surface 35a that is a total reflection surface. This reflecting surface 35a performs total reflection if the incident angle α (θ) of the signal light beams is within the range specified by the above conditional expression (2). However, if the incident angle α (θ) of the signal light beams is outside the range specified by expression (2), then it is necessary to provide a reflective coating to reflecting surface 35a. Further, the surface facing converging lens 15 forms an incident surface 35b, and the surface facing image forming lens 19 forms a radiating surface 35c.

Optical fiber 18 is embedded and fixed in place inside second triangular prism 36, and its incident end surface 18a projects outward from inclined surface 36a and is positioned in the same plane as reflecting surface 35a of first triangular prism 35, to form a light receiving surface.

For this reason, when the optical axis of the signal light beams coincides with reference optical axis A, the signal light beams are received into incident end surface 18a on reflecting surface 35a. When the optical axis of the signal light beams deviates from reference optical axis A, then the signal light beams pass through incident surface 35b, are reflected at reflecting surface 35a, pass through radiating surface 35c and are approach image forming lens 19.

Note that the second triangular prism 36 does not transmit light beams. Therefore, as in the case of the third modification, it is not absolutely essential that it be a prism. Further, it is acceptable to interpose a phosphor bronze plate or the like, for use as a mask member 37, in the space interval between first triangular prism 35 and second triangular prism 36.

Note that in the above-described embodiments, the angle was adjusted by biaxial rotation of galvano mirror 12 so that the signal light beams incident on a light receiving surface such as the incident end surface 18a of optical fiber 18, or photodetector surface 29a. However, in place of this design, it is also acceptable to mount optical system 10 or optical system 22 on a stage or the like, and provide an adjusting member for performing angular adjustment of these optical systems as a whole.

An explanation will now be made of an example of an optical system of this type, which is shown in FIG. 10 as a third embodiment. Optical system 38 shown in FIG. 10 omits the galvano mirror 12 from optical system 10 of the first embodiment. An afocal optical system 39 is disposed along the extension line of reference optical axis A that incidents on converging lens 15 in this optical system 38. In addition, in place of optical fiber 18, a photodetector 40 is disposed to incident surface 16a of triangular prism 16 inside optical beam detection device 11. Afocal optical system 39, optical beam detection device 11 and controller 13 are held in an integral manner by gimbal stage 41. Gimbal stage 41 is held to enable biaxial rotation, where the X and Y axes intersect for example, by means of a rotating axis 43 which is held by support member 42. Gimbal stage 41, support member 42 and rotating axis 43 form adjusting member 44. Adjusting member 44 rotates optical system 38 as a whole, which is held by gimbal stage 41, so as to eliminate the deviation between the optical axis of the signal light beams and reference optical axis A that is detected by controller 13.

In other words, the signal light beams of parallel light incidenting from the outside are input to afocal optical system 39, to form a specific beam diameter. When the optical axis of the signal light beams coincides with reference optical axis A, the signal light beams incident on photodetector 40 and are output as an electrical signal. When the optical axis of the signal light beams does not coincide with reference optical axis A, then the signal light beams are reflected at reflecting surface 16b of triangular prism 16 and incident on CCD 20. CCD 20 detects the direction and amount of deviation in the signal light beams with respect to photodetector 40. Controller 13 calculates the amount of correction based on the direction and amount of deviation in the signal light beams. Further, controller 13 outputs a correction signal based on this calculated result, and gimbal stage 41 is rotated by a specific amount about the two axes. As a result, the signal light beams are driven into photodetector 40, and the optical axis of the signal light beams is made to coincide with reference optical axis A.

Note that it is acceptable to provide a galvano mirror 12 in front of afocal optical system 39, separate from gimbal stage 41. In this case, small deviations in the optical axis of the signal light beams can be adjusted using galvano mirror 12, while large deviations in the optical axis can be adjusted using gimbal stage 41. As a result, efficiency of adjustment improves.

In each of the preceding embodiments, galvano mirror 12 was formed as a flat reflecting surface. However, it is also acceptable to form galvano mirror 12 as a fresnel or DOE (diffraction optical element) surface which have the same action. In other words, the essence of the present invention is not limited to a surface form of this type. Namely, an optical sensor such as a PSD (semiconductor position detecting element), PD array (photodiode array) or the like, may be employed in place of CCD 20 as a light detecting element.

In addition, the optical beam detection device 11 and optical systems 10, 22 and 38 according to the various embodiments described above can be optimally employed for detection of the inclination of the optical axis in a light receiving device that performs light acquistion and tracking such as in spatial light communications. For example, a light transmitting device part is formed by disposing an afocal optical system with respect to the galvano mirror 12 of optical system 10 or optical system 22, at a position that is to the rear of the direction of progression of the signal light beams, and disposing a beam splitter, collimeter, lens and light source at a position that between optical beam detection device 11 that is in front of galvano mirror 12 and thereof. The optical path proceeds in a direction that is opposite the incident direction of the light, enabling a communication signal to be radiated from the afocal optical system. In addition, a light receiving device part is formed by disposing the end surface of an optical communications fiber or a photodetector to the light receiving surface, and extracting a communications signal from the received light. It is also acceptable to form an optical system that is capable of bidirectional spatial light communication by preparing two devices of the above design capable of transmitting and receiving light, and disposing them at separate locations in opposition to one another. As a result, by relatively moving the devices capable of transmitting and receiving light, it is possible to respond to light having wide angles of incidence, such as for carrying out optical tracking.

The optical beam detection device of the present invention detects deviation from a reference optical axis in the optical axis of light beams, comprising:

a converging member for converging the light beams;

a light receiving surface that is disposed near the position where light beams having an optical axis that coincides with the reference optical axis are converged by the converging member;

an optical path deflector for deflecting light beams that have an optical axis that deviates from the reference optical axis, after they have passed through the converging member; and

a light detecting element for detecting light beams that have been deflected by the optical path deflector.

In the present invention, when the optical axis of the incidented light beams coincides with a reference optical axis, it is possible to form convergent light without generating loss by using a converging member during the light's approach toward the light receiving surface, and for this convergent light to be received at the light receiving surface. For this reason, there is no loss in the light beams received and detected. On the other hand, when the optical axis of the light beams deviates from the reference optical axis, then at least a portion of the light beams project beyond the light receiving surface.

In this case, the light beams that miss the light receiving surface are deflected at the optical path deflector and are guided to a light detecting element. The light detecting element then detects a detection signal having information on the deviation between the optical axis and the reference optical axis (i.e., information on the angle of inclination of the optical axis of the light beams, etc.) based on the position of light reception on the light receiving surface.

In this way, the inclination of the optical axis of the light beams can be measured with respect to the reference optical axis. Accordingly, by providing a means or function to the light detecting element for adjusting the optical axis of the light beams based on these measured results, so that no light beams are detected, it is possible to correct the inclination of the optical axis of the light beams for a wider range of incident angles. Further, since it is not necessary that a portion of the light spot consisting of the light beams always overlap the light receiving area, it is possible to widen the range for detecting deviation in the optical axis. In other words, it is possible to respond to initial acquistion of the spatial light communication, or re-acquisition when there is a large deviation (even if light communication is interrupted).

In the optical beam detection device of the present invention, it is desirable that the light receiving surface be integral with the optical path deflector.

As a result, the design of the light receiving surface and the optical path deflector can be simplified. Assembly and the like are thus simplified, and the light receiving surface can be protected by the optical path deflector. Note that the light receiving surface includes the end surface of the optical fiber, the photodetector surface, the photoelectric conversion surface, and the like.

In the optical beam detection device of the present invention, it is desirable that the optical path deflector have a reflecting surface that is disposed to the periphery of the light receiving surface.

As a result, light beams that have missed even a portion of the light receiving surface can be directed with certainty to the light detecting element by deflecting the optical path using the reflecting surface of the optical path deflector.

Note that the “periphery of the light receiving surface” refers to the area from just in front to just after the light receiving surface in the direction of progression of the reference optical axis, and includes the position of convergence by the converging member. In addition, in the case where light beams approaching the light receiving surface deviate from the reference optical axis, then the “periphery of the light receiving surface” includes the area reached by these light beams.

In the optical beam detection device of the present invention, it is desirable that the optical path deflector have a reflecting surface and that this reflecting surface be inclined with respect to the reference optical axis.

When the optical axis of the light beams is inclined with respect to the reference optical axis, then the light beams that have missed the light receiving surface are deflected at the light reflecting surface and can be directed to the light detecting element with good efficiency.

In the optical beam detection device of the present invention, it is desirable that the optical path deflector includes an incident surface that is provided to the periphery of the light receiving surface in an integral manner therewith, and that forms a transmitting surface; and a reflecting surface that is disposed inclined with respect to the reference optical axis and that deflects light beams that have passed through the incident surface.

In this case, light beams that have missed the light receiving surface pass through the incident surface, enter inside the optical path deflector, are deflected at the reflecting surface in a direction other than the direction of the transmitting surface, and are directed to the light detecting element. The light receiving surface and the incident surface are in approximately the same plane, so that working is easy. Further, since the reflecting surface is positioned inside the optical path deflector, handling is facilitated.

In the optical beam detection device of the present invention, it is desirable that the incident surface of the optical path deflector be a surface-reflecting mirror to which a reflective coating has been applied.

By making the incident surface a surface-reflecting mirror, the position of deflection is located closer to the converging member, making it possible to design the device to be smaller. Note that the surface-reflecting mirror can be formed as a parallel plate, in which case, it can be manufactured inexpensively. In addition, it is also acceptable to form the surface-reflecting mirror by means of a prism. In this case, the angles can be formed with high precision during molding, so that angular adjustment during assembly of the optical beam detection device is easy.

In the optical beam detection device of the present invention, it is desirable that the optical path deflector be a prism.

Angular adjustment during assembly of the optical beam detection device is easy. In particular, the work to form the optical path deflector and the light receiving surface in an integral manner is made easy. Moreover, if the light receiving surface is provided as a photoelectric conversion surface, then a space is formed for housing the photoelectric conversion element, and positional accuracy can be achieved simply by dropping in the element, making assembly easy. If an optical fiber is used for the light receiving surface, then a hole for the fiber may be formed in the prism, and the fiber may be inserted, and fixed in place with an adhesive agent. As a result, positional adjustment with respect to the reference optical axis is easy.

In the optical beam detection device of the present invention, it is desirable that the following conditional expression be satisfied:
25°≦|θ|≦65° (1)
where θ is the angle of incidence at which the optical axis of light beams incident on the reflecting surface for deflecting light beams in the optical path deflector.

Within the range described by the above conditional expression (1), it is possible to prevent interference between optical elements like the light detecting element and the optical path deflector, and to realize a smaller device. In contrast, at values below the lower limit, the light detecting element nears the optical axis of the incidented light beams, so that there is a possibility of interference between the converging member and the light detecting element. When the value of θ exceeds the upper limit, then the light detecting element is greatly separated from the optical axis of the incident light, resulting in an increase in the size of the device. In particular, when the angle of incidence θ is 45°, for example, then the incident light and the radiating light have an orthogonal relationship, and disposition of an optical element such as a light detecting element becomes easy. Note that it is desirable if the range for incident angle θ is set as indicated by following expression (1)′:
30°≦|θ|≦60° (1)′

In the optical beam detection device of the present invention, it is desirable that the following conditional expression be satisfied:
Sin⁻¹(1/N)≦α (2)
where N is the refractive index of the wavelength employed in the prism medium, and α is the angle of incidence of the principal light rays in the total angle of view that incident on the reflecting surface of the prism.

In the case where the reflecting surface is inside an optical path deflector such as a prism or the like, and the light beams that pass through the inside of the deflector are reflected at a reflecting surface, the light beams can be totally reflected without providing a reflective coating to the reflecting surface by incidenting the light beams on the reflecting surface at an angle of incidence a that is greater than the critical angle Sin⁻¹(1/N).

In the optical beam detection device of the present invention, it is desirable that the following conditional expression be satisfied:
70°<β<110° (3)
where β is the angle formed by the light receiving surface and the optical axis of the light beams.

When angle β is within the above range, light beams having an optical axis that coincides with the reference optical axis can be received on the receiving surface without loss. When angle β is outside the range specified by the above expression (3), there is a concern that the light beams will be truncated. In particular, when β is 90°, the optical axis becomes perpendicular to the light receiving surface, and, theoretically, the coupling efficiency becomes maximal. However, in the case of an optical system in which there is an effect from returning light due to reflection, then it is desirable that the light receiving surface be slightly inclined from 90° with respect to the optical axis, within the range specified by expression (3).

Note that is even more desirable that angle β be set within the range specified by the following expression (3)′:
80°<β<100° (3)′

The optical system according to the present invention is provided with an optical beam detection device, and a controller for adjusting the optical axis of the light beams so that it coincides with the reference optical axis, based on the detection signal for the light beams detected by the light detecting element.

In the present invention, when the light beams project beyond the light receiving surface, the controller calculates a correction value for the light beams with respect to the reference optical axis, based on the detection signal for the amount and direction of deviation in the light beams measured by the light detecting element. Inclination and the like are corrected so that the optical axis of the light beams coincides with the reference optical axis. As a result, the light beams are driven to the light receiving surface.

It is desirable that the optical system according to the present invention be further provided with a light deflecting element for adjusting the direction of the light beams that are approaching the converging member, and that the controller calculate the deviation of the optical axis of the light beams with respect to the reference optical axis and control the light deflecting element so as to diminish deviation of the optical axis.

The correction of the inclination, etc. of the optical axis of the light beams with respect to the reference optical axis is carried out by controlling the direction of deflection using a light deflecting element such as a galvano mirror.

It is desirable that the optical system according to the present invention be further provided with an adjusting member for adjusting the inclination of the optical system overall with respect to the light beams that are approaching the converging member, and that the controller calculate the deviation in the optical axis of the light beams with respect to the reference optical axis and control the adjusting member so as to diminish deviation of the optical axis.

In the present invention, the adjusting member is employed to adjust the position of the optical system as a whole, in the direction that diminishes the deviation in the optical axis of light beams incidenting from the outside. Correction of the inclination, etc. of the optical axis of the light beams with respect to the reference optical axis is carried out by controlling the inclination of the optical system as a whole through use of an adjusting member such as a gimbal stage or the like.

By employing the optical beam detection device of the present invention, it is possible to use a simple structure to detect light having a wide range of incident angles without generating loss.

Further, by employing the optical system of the present invention, it is possible to use a simple structure to detect light having a wide range of incident angles and control deviation in the light beams without generating loss.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. An optical beam detection device for detecting deviation in the optical axis of light beams from a reference optical axis, comprising:
a converging member for converging said light beams;
a light receiving surface that is disposed near the position where said light beams that have an optical axis that coincides with said reference optical axis are converged by said converging member;
an optical path deflector for deflecting said light beams that have an optical axis that deviates from said reference optical axis, after they have passed through said converging member; and
a light detecting element for detecting said light beams that have been deflected by said optical path deflector.

2. An optical beam detection device according to claim 1, wherein said light receiving surface is formed in an integral manner with said optical path deflector.

3. An optical beam detection device according to claim 1, wherein said optical path deflector has a reflecting surface that is disposed to the periphery of said light receiving surface.

4. An optical beam detection device according to claim 1, wherein said optical path deflector has a reflecting surface, and said light reflecting surface is inclined with respect to said reference optical axis.

5. An optical beam detection device according to claim 1, wherein said optical path deflector has an incident surface that is provided to the periphery of said light receiving surface in an integral manner therewith, and forms a transmitting surface; and a reflecting surface that is disposed inclined with respect to said reference optical axis and deflects light beams that have passed through said incident surface.

6. An optical beam detection device according to claim 1, wherein the incident surface of said optical path deflector is a surface-reflecting mirror to which a reflective coating has been applied.

7. An optical beam detection device according to claim 1, wherein said optical path deflector is a prism.

8. An optical beam detection device according to claim 1, wherein the following conditional expression is satisfied:
25°≦|θ|≦65°
where θ is an angle of incidence at which the optical axis of light beams incident on the reflecting surface for deflecting light beams in said optical path deflector.

9. An optical beam detection device according to claim 7, wherein the following conditional expression is satisfied:
Sin⁻¹(1/N)≦α
Where N is a refractive index of the wavelength employed in said prism medium, and α is an angle of incidence of the principal light rays in the total angle of view that incident on the reflecting surface of said prism.

10. An optical beam detection device according to claim 1, wherein the following conditional expression is satisfied:
70°<β<110°
where β is an angle formed by said light receiving surface and the optical axis of the light beams.

11. An optical system comprising:
an optical beam detection device according to claim 1; and
a controller for adjusting the optical axis of said light beam so that it coincides with said reference optical axis, based on the detection signal of the light beams detected by said light detecting element.

12. An optical system according to claim 11, further comprising a light deflecting element for adjusting the direction of the light beam that are approaching said converging member,
wherein said controller calculates the deviation of the optical axis of the light beams with respect to said reference optical axis and controls said light deflecting element so as to diminish deviation of said optical axis.

13. An optical system according to claim 11, further comprising an adjusting member for adjusting the inclination of the whole of said optical system overall with respect to the light beams that are approaching said converging member,
wherein said controller calculates the deviation in the optical axis of the light beams with respect to said reference optical axis and controls said adjusting member so as to diminish deviation of said optical axis.
